(19) United States
(12) Patent Application Publication
(10) Pub. No.: US 2010/0328208 A1
(43) Pub. Date: Dec. 30, 2010

(54) ELECTRODE PATTERNS FOR CAPACITANCE SENSITIVE TOUCHPAD

(76) Inventors: Steven M. Austin, Riverton, UT (US); Jared G. Bytheway, Sandy, UT (US)

Correspondence Address: MORRISS OBRYANT COMPAGNI, P.C., 734 EAST 200 SOUTH, SALT LAKE CITY, UT, 84102, US

(21) Appl. No.: 12/815,083

(22) Filed: Jun. 14, 2010

Related U.S. Application Data
(60) Provisional application No. 61/186,781, filed on Jun. 12, 2009.

(51) Int. Cl. G09G 5/08

(52) U.S. Cl. 345/157

(57) ABSTRACT

A new layout for X, Y and Sense electrodes that enables a touchpad to be constructed using fewer layers while increasing visual clarity, transmissivity, sensitivity and linearity, wherein the electrodes are disposed in a pattern that uses spiral shapes that do not require electrodes to cross over any other electrodes.

### CROSS REFERENCE TO RELATED APPLICATIONS

This document claims priority to and incorporates by reference all of the subject matter included in the provisional patent application docket number 4617.CIRQ.PR, having serial number 61/186,781.

### BACKGROUND OF THE INVENTION

1. Field of the Invention

This invention relates generally to touchpads. More specifically, the present invention is a system and method for laying out a pattern of electrodes for a capacitance sensitive touchpad that is an improvement over the prior art.

2. Description of Related Art

There are several designs for capacitance sensitive touchpads. One of the existing touchpad designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

The X and Y electrodes are typically disposed on a substrate in a grid, with the Sense Electrode wrapping around, intertwined among them, or some combination of the two. It would be an improvement over the prior art to provide new patterns for X, Y and Sense electrodes that reduced the number of layers of a touchpad, increased transmissivity, reduced visibility to electrodes when disposed over a display screen and increased sensitivity and linearity of the touchpad.

### BRIEF SUMMARY OF THE INVENTION

An embodiment of the invention is to provide a new layout for X, Y and Sense electrodes that enables a touchpad to be constructed using fewer layers while increasing visual clarity, transmissivity, sensitivity and linearity, wherein the electrodes are disposed in a pattern that uses spiral shapes that enable electrodes to extend into the cells of adjacent electrodes, wherein the presence of a finger has a larger effect on adjacent electrodes than it would otherwise have in a touch sensor having relatively large cells.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a first embodiment of a touchpad that is found in the prior art, and which is adaptable for use in the present invention.

FIG. 2 is a graph showing the typically linearity in measurements showing position of an object on a touchpad when cells are small.

FIG. 3 is a graph showing the output as a step-wise function when linearity is reduced in measurements showing position of an object on a touchpad when cells are relatively large.

FIG. 4 is a schematic diagram of a layout of X, Y and Sense electrodes for a capacitance sensitive touchpad of the present invention. The X electrode is shown in contrast.

FIG. 5 is the same schematic drawing as FIG. 4 but the Sense electrode 50 is now shaded to illustrate the fact that it shares the same substrate layer as the X electrode, but not the Y electrode.

FIG. 6 is a schematic drawing of the Y electrode 60 which is on a different layer than the X and Sense electrodes.

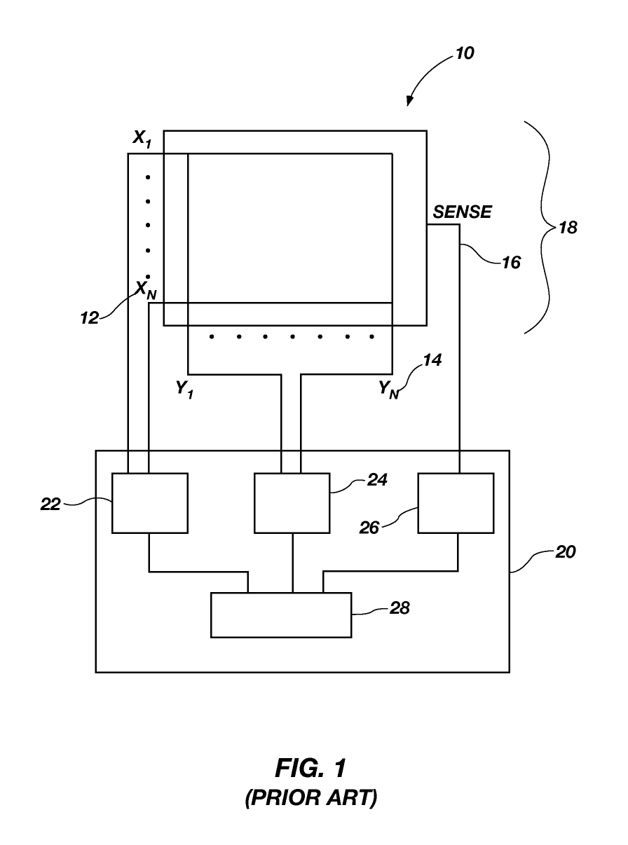

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The advantages of the electrode patterns in the embodiments of the present invention are to reduce the number of layers of a touchpad, increase transmissivity, reduce visibility to electrodes when disposed over a display screen and increase sensitivity and linearity of the touchpad. These advantages are obtained by creating spiral branches for the X and Y electrodes. If a Sense electrode is being used, the spiral shape is also used for this electrode as well.

Before showing a specific implementation of the X, Y and Sense electrodes, it should be understood that a prior art capacitance sensitive touch sensor uses a grid of electrodes to drive signals and to receive signals. Analysis of the signals received enables determination of the location of an object that is affecting the signals that are being driven onto the electrodes.

In a multi-layer touch sensor, electrodes are disposed on different layers to create a capacitance between one electrode layer to another that is affected by the presence of a conductive object, such as a finger. In the prior art, X electrodes are typically straight conductive lines that orthogonally cross over straight conductive lines that form the Y electrodes. For the purposes of this invention, a cell is defined as a junction wherein a single X electrode crosses over a single Y electrode. One problem with large touchpads is that the size of the cells is generally large. In other words, the space between electrodes and thus the space between junctions is relatively large. A large cell can thus be defined as a cell that will result in the undesirable creation of a stepwise function when used as part of a larger touch sensor.

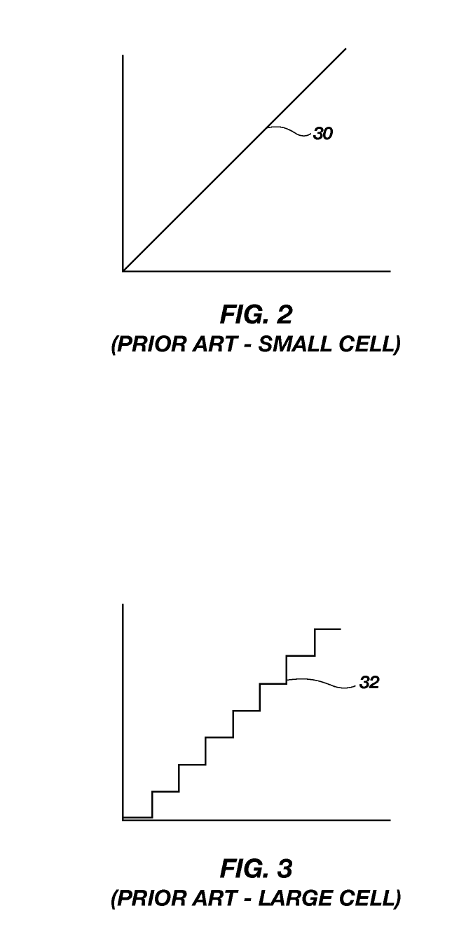

As will be understood by those skilled in the art, position output for an object being tracked using a touch sensor having large cells is less than ideal. For a touch sensor having relatively small cells, the position of an object is a represented by a smooth line 30 which can be defined as an output that is linear as shown in FIG. 2. In contrast, FIG. 3 shows that when cells are too large, the result is an output function 32 that is shown as a stepwise pattern having discrete jumps because of the large spacing between immediately adjacent electrodes.

Linearity is typically poor when using large cells. The present invention does not eliminate large cells, but overcomes the problem of having to use large cells by having each electrode reach into more than a single cell. In other words, by substituting a different shape for the electrodes other than a straight line, each electrode is now present in more than a single cell. In effect, a single electrode reaches into adjacent cells so adjacent electrodes are closer to the finger despite the large cell size would otherwise allow using conventional electrode lines.

It is noted that the exact number of X electrodes and Y electrodes that are present in each cell should not be considered a limiting factor. What is important in the present invention is that the presence of the finger has an effect on more than one electrode of the same type, and more dramatically than is normally the case because the adjacent electrode is now closer to the finger that is present in the cell.

A finger has always had an effect on adjacent electrodes, but the present invention overcomes the problem of distance between cells. In other words, the presence of a finger has the greatest effect on the X electrode that it is nearest to it, a substantially smaller effect on the nearest adjacent X electrode, and will have an ever diminishing effect on increasingly farther X electrodes as the distance to the next X electrode increases. When cells are large and adjacent X electrodes are thus further and further apart, the effect of the finger is smaller, thereby resulting in the step-wise function and a reduction in linearity and sensitivity.

However, by causing at least the next adjacent X electrode to extend its presence into the cell of all neighboring X electrodes, the effect of the finger on the adjacent electrode will be larger, while still not as large as the main X electrode in the cell, thereby increasing linearity because the finger will have a greater effect upon the adjacent X electrode. It should be understood that while the X electrodes are called out in the examples given, the result is identical for Y electrodes.

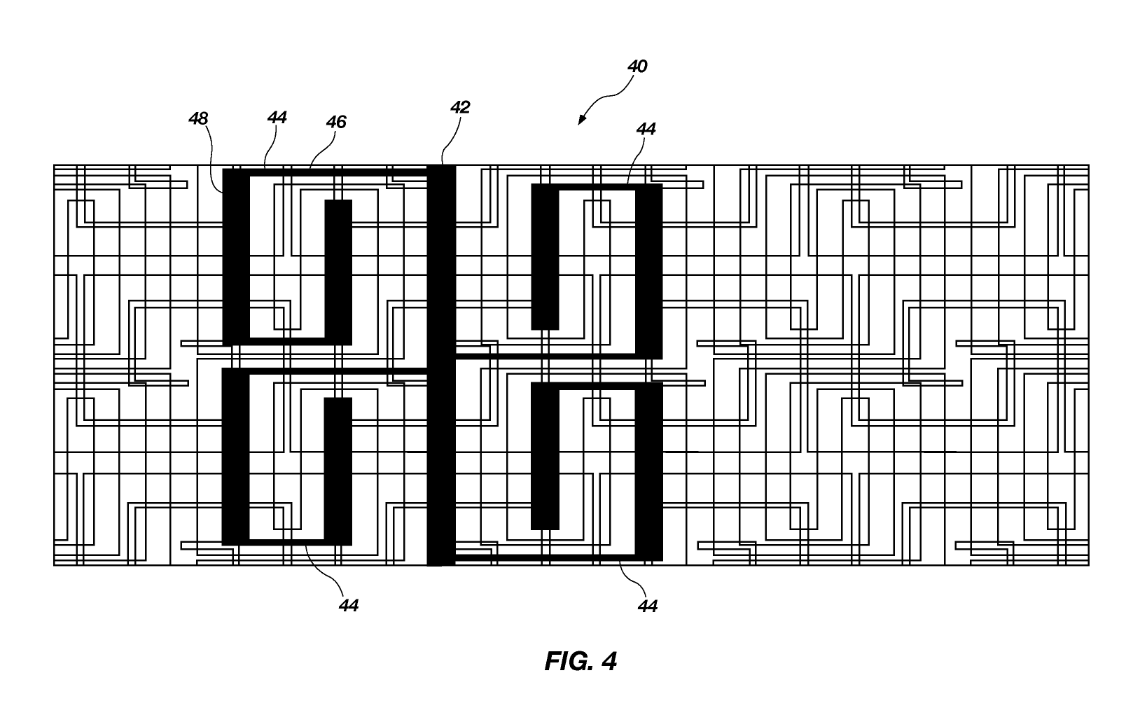

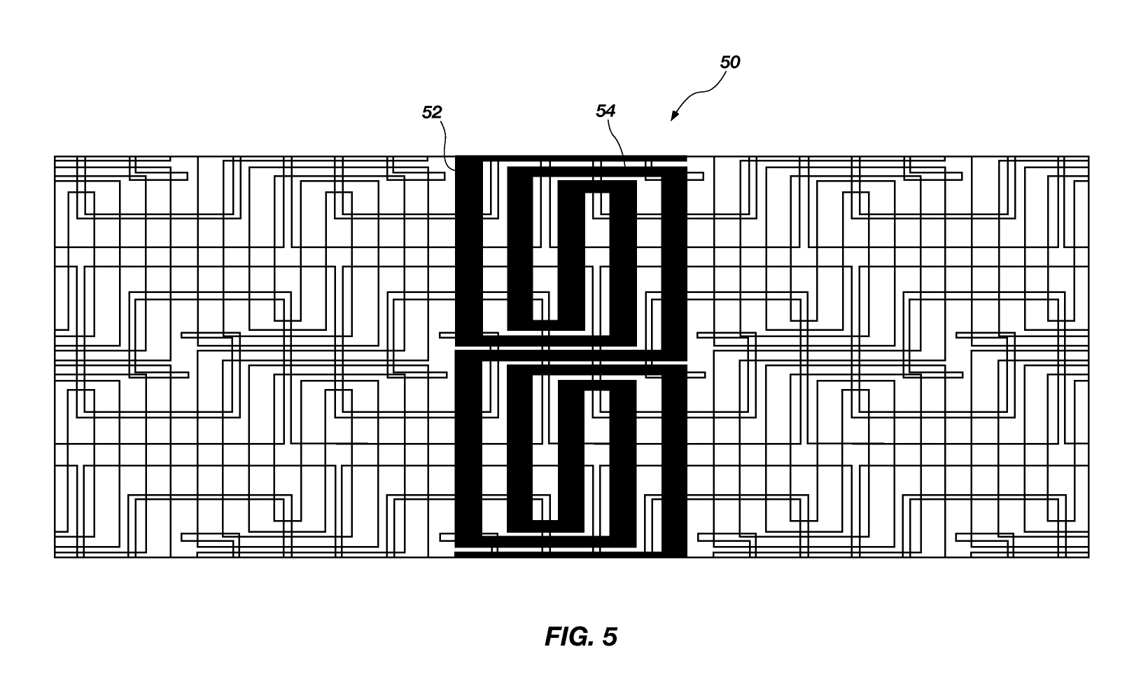

We can now see some embodiments of possible shapes that enable electrodes to extend their physical presence into adjacent cells. FIG. 4 is a schematic diagram of a layout of X, Y and Sense electrodes for a capacitance sensitive touchpad of the present invention which has large cells. As stated previously, prior art X and Y electrodes are typically disposed in a plurality of parallel straight lines. The X electrodes are disposed orthogonally with respect to the Y electrodes. The Sense electrode, if used, might be intertwined, interdigitated, or wrapped around the outside of the X and Y electrodes. What is desirable is that the Sense electrode gets as close as possible to the junctions in each cell in order to receive as much of the resulting signal as possible.

In FIG. 4, the X electrode 40 has been darkened with respect to other electrodes present in order to highlight a main vertical trunk 42. In the prior art, this would be the entire extent of the X electrode. However, in the present invention, four branches 44 are shown extending outward from the main trunk 42. These four branches 44 extend into adjacent cells of other X and Y electrodes. The direction of curvature of the spirals should not be considered a limiting factor in the design. The shape and thickness of the spirals, and the exact path followed by them can be modified in order to best reach into adjacent cells.

While only four branches 44 are shown in FIG. 4, the X electrode 40 includes a plurality of branches that extend outward from the main trunk 42 along its entire length in a symmetrical manner. The same branches are present on all X electrodes used in the touch sensor.

It is noted that the X electrode is shown having some wide segments 46 and thin segments 48. The thin segments 48 are used when the X electrode 40 is being extended in a direction that is orthogonal to the main trunk 42, and wide segments 46 are used when the X electrode 40 is being extended in a direction that is parallel to the main vertical trunk 42. A thicker segment means that more of a signal can be received or driven. Nevertheless, the thickness of the electrode segments can be adjusted and should not be considered to be a limiting factor. In an alternative embodiment, the thickness of the X electrode segments can be made uniform.

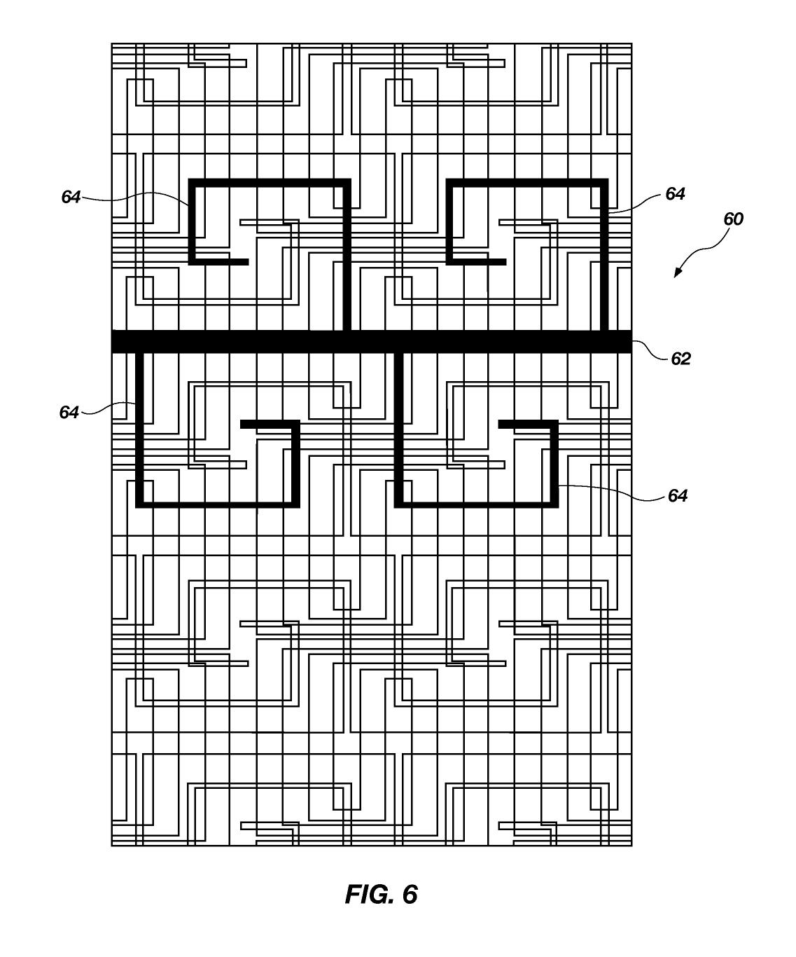

FIG. 5 is part of the same schematic drawing as FIG. 4. In this embodiment, the Sense electrode 50 shares the same substrate layer as the X electrode 40. A portion of the Sense electrode 50 is shaded so that the spiral nature is also evident. Note that the Sense electrode 50 never cross over the X electrode 40 because they are on the same substrate layer. The substrate layer with the Y electrode is seen through the X electrode 40 and the Sense electrode 50 and will be shown in detail in FIG. 6, but the electrodes on the same layer never cross each other.

It is noted that the Sense electrode 50 is shown having some wide segments 52 and thin segments 54. A thicker segment means that more signal can be received or driven. Nevertheless, the thickness of the electrode segments can be adjusted and should not be considered to be a limiting factor. In an alternative embodiment, the thickness of the Sense electrode 50 segments can be made uniform. It is also noted that the coverage of the area occupied by the Sense electrode is intentionally made as uniform as possible to increase the accuracy of the touch sensor.

FIG. 6 is a schematic drawing of the Y electrode 60 which is on a different layer than the X electrode 40 and the Sense electrode 50. A sample of the Y electrode 60 is shaded to illustrate the main horizontal trunk 62 (which is co-planar but orthogonal to the main vertical trunk 42 of the X electrode 40) and the four branches 64 that form spiral shapes that reach into adjacent cells.

It is noted that the main horizontal trunk 62 of the Y electrode 60 is thicker than all four branches 64. This should not be considered to be a limiting factor and can be modified if desired without affecting the essence of the present invention.

It was previously stated that the purpose of the present invention is to reduce the number of layers of a touchpad, increase transmissivity, reduce visibility to electrodes when disposed over a display screen and increase sensitivity and linearity of the touchpad.

The number of layers is reduced by combining the Sense line and one of the other electrodes, either X or Y. The decision is arbitrary, and either electrode can be chosen.

The ability of the present invention to reduce visibility is a result of a more uniform distribution of electrodes on the substrate. By making distribution of electrodes uniform, there are no visual “disturbances” to distract the eye.

Linearity and overall performance are improved by the present invention because of the enhanced-distribution of the X, Y and Sense electrodes. Specifically, by enabling the X and Y electrodes to reach into adjacent cells, all aspects of touch sensor performance are improved.

Sensitivity of the touch sensor that is created using the layout of X, Y and Sense electrodes shown in FIGS. 4, 5 and 6 is increased because of the proximity of the Sense electrode 50 to the X electrode 40 and the Y electrode 60.

Experimentation has shown that another advantage of the layout of the X, Y and Sense electrodes 40, 60 and 50 is that an even larger cell structure is made possible. In other words, linearity can be maintained even while using cells that are substantially larger.

In an alternative embodiment, the Y electrode is combined with the Sense electrode on a same side of a substrate, and the X electrode is on an opposite side of the substrate.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for increasing linearity of a capacitance sensitive touchpad, said method comprised of the steps of:
1) providing a plurality of parallel X electrodes defined as main trunk electrodes and disposed on a first side of a substrate;
2) providing a plurality of parallel Y electrodes defined as main trunk electrodes and disposed on a second side of the substrate, wherein the Y electrodes are co-planar with and orthogonal to the X electrodes, and wherein each overlapping X electrode and Y electrode defines a cell; and
3) providing a plurality of branch electrodes that extend off the main trunk electrodes of the X and Y electrodes, wherein each of the branch electrodes extends at least partway towards an adjacent cell.
